(19) United States
(12) Patent Application Publication
(10) Pub. No.: US 2015/0085799 A1
(43) Pub. Date: Mar. 26, 2015

(54) DATA RATES IN MOBILE RADIO SYSTEMS

(71) Applicant: TAIT LIMITED, Christchurch (NZ)

(72) Inventor: Trevor John LAUGHTON, Tai Tapu (NZ)

(21) Appl. No.: 14/495,334

(22) Filed: Sep. 24, 2014

(30) Foreign Application Priority Data
Sep. 24, 2013 (NZ) 615898

(51) Int. Cl. H04W 72/12; H04W 88/06; H04W 16/28

(52) U.S. Cl. CPC H04W 72/1215; H04W 16/28; H04W 88/06
USPC 370/329

(57) ABSTRACT

Broadband networks for cellular operation are relatively short range and are deployed with infrastructure to serve the needs of a relatively high density of users. Land Mobile Radio (LMR) networks are relatively long range and deployed with infrastructure to serve a relatively low density of users. Methods are described which enable mobile devices to use an LMR network to coordinate operation of a broadband network to achieve higher data rates or use other aspects of the broadband network.

This application claims priority to New Zealand patent application number NZ 615898, filed Sep. 24, 2013, which is incorporated herein by reference.

### FIELD OF THE INVENTION

This invention relates to data rates in mobile radio systems and particularly but not only to systems which combine two or more wireless protocols such as P25 and LTE.

### BACKGROUND TO THE INVENTION

Long range communications are a key requirement for mission critical systems such as public safety and utility operations. Such systems are commonly private networks and are characterised by a need for operation over very wide geographic areas while offering service to a relatively low density of users. Land Mobile Radio (LMR) systems such as P25 have been a typical choice for such solutions because of its ability to offer economically acceptable coverage. This has typically been used for mission critical voice communication. DMR and Tetra are similarly used in some countries.

Increasingly public safety users require more information. Maps, electronic forms and video are all examples of applications that are now aiding public safety and critical infrastructure such as electrical distribution in their operations. New technology such as LTE (Long Term Evolution), part of the 3GPP standards represent a communications path that can support such applications. There is however a challenge. LTE is not typically designed for economic long range operation in the same way as LMR. LTE represents a broadband technology which means the power of a transmission is spread over a relatively wide frequency allocation. LMR is a narrow band technology and as such its transmission is concentrated in a relatively narrow allocation of spectrum. In concentrating power in a relatively narrow allocation of spectrum, LMR is able to offer superior range.

Cellular technology such as LTE provides an effective means of communicating relatively high rate data. This is typically accomplished using a relatively high density of cellular base sites to serve a relatively large population density of users. Commercial consumers are an example. LMR technology provides an effective means of communicating at a relatively low data rate. This is typically accomplished using a relatively low density of LMR base sites to serve a relatively low population density of users. Emergency services are an example.

There exists a problem when relatively high data rates need to be communicated to a relatively low user population density. In this scenario, the economics of deploying broadband cellular technology can become questionable and LMR technology is unable to offer the required relatively high data rates required. There exists therefore a gap in the suitability of LTE or LMR in serving the need for high data rate over a wide area.

### SUMMARY OF THE INVENTION

It is an object of the invention to provide for improved long range communications requiring relatively high data rates, by combining LMR and LTE.

In one aspect the invention resides in a method of communicating with a mobile radio device, including: providing a first network of base stations which use a first bearer having a relatively low data rate, providing a second network of base stations which use a second bearer having a relatively high data rate, receiving location data from the mobile device at a base station using the first bearer, providing a directional beam toward the location of the mobile device at a base station using the second bearer, and transmitting data to or receiving data from the mobile device using the directional beam and the second bearer.

In a further aspect the invention resides in a system for communicating with a mobile radio device, including: a first network of base stations which use a first bearer having a relatively low data rate, a second network of base stations which use a second bearer having a relatively high data rate, and a controller having a memory containing software instructions which cause the controller to: receive location data from the mobile device at a base station using the first bearer, provide a directional beam toward the mobile device at a base station using the second bearer, and transmit data to or receive data from the mobile device using the directional beam and the second bearer.

Generally, the first network of base stations provides omnidirectional relatively long range RF communication and the second network of base stations provides directional relatively short range RF communication. The first bearer is LMR, DMR, TETRA or other relatively narrowband RF bearer, and the second bearer is LTE or other relatively broadband RF bearer. The method may further include receiving data at the mobile device relating to the directional beam, and moving the mobile device into the directional beam.

In a further aspect the invention resides in a method of communicating with a mobile radio system, including: providing a mobile device having capability for using either of a first bearer with a relatively low data rate or a second bearer with a relatively high data rate, receiving data from a first base station using the first bearer, relating to location of a second base station which uses the second bearer, providing a directional beam from the mobile device toward the location of the second base station which uses the second bearer, and transmitting data from or receiving data at the mobile device using the directional beam and the second bearer.

In a still further aspect the invention resides in mobile device for communicating with a mobile radio system, including: a transceiver arrangement having capability for using either of a first bearer with a relatively low data rate or a second bearer with a relatively high data rate, and a controller having a memory containing software instructions which cause the mobile device to: receive data from a first base station using the first bearer, relating to location of a second base station which uses the second bearer, provide a directional beam from the mobile device toward the second base station which uses the second bearer, and transmit data or receive data at the mobile device using the directional beam and the second bearer.

### BRIEF DESCRIPTION OF THE DRAWINGS

Preferred embodiments of the invention will be described with respect to the accompanying drawings, of which:

FIGS. 1, shows a typical LMR system with a typical broadband system in the same geographic area.

FIG. 2 shows the broadband beam being extended to serve distant users.

FIG. 3 shows a flow chart for the mobile device communicating location data.

FIG. 4 shows a flow chart for the network side of an integrated LMR and broadband system.

FIG. 5 shows an alternative system where multiple directional antennae are located at a base site.

FIG. 6 shows switching apparatus for selecting between the antennae in FIG. 5.

FIG. 7 shows a process for selecting which antenna to use.

FIG. 8 shows one implementation of a mobile device.

FIG. 9 illustrates a simple application for directing users to the nearest broadband connectivity.

FIG. 10 shows the extended range effect of a directional antenna at the mobile device.

### DESCRIPTION OF PREFERRED EMBODIMENTS

Referring to the drawings it will be appreciated that the invention can be implemented in a range of different ways using a variety of different narrowband and broadband communication systems such as LMR and LTE.

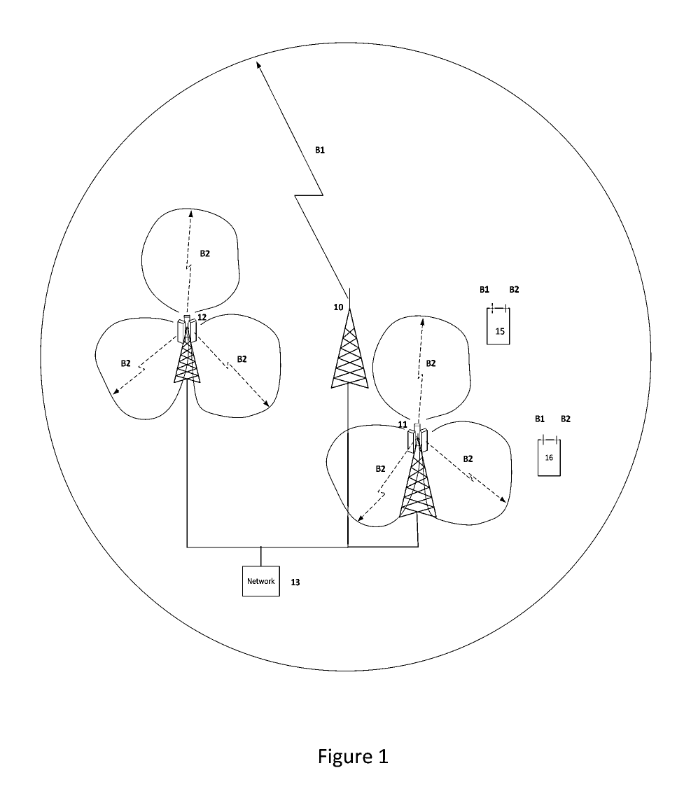

FIG. 1 illustrates a traditional LMR system overlaid with a traditional broadband or cellular system. Each system includes a network of base stations which transmit according to respective bearer protocols. LMR sites are commonly deployed with a relatively high powered base station through an omnidirectional antenna yielding wide area coverage. In this case the transmission is occurring on a frequency pair for uplink and downlink, referred to as bearer B1, operating at site 10. Broadband sites are typically deployed as a triad of base stations serving three directional antennas creating sectors of connectivity. In this case the transmission is occurring on a different frequency pair, referred to as bearer B2 operating at sites 11 and 12. The LMR and cellular networks are typically separate but in this example are shown joined through an idealised control system 13.

Also shown in FIG. 1 are mobile devices 15, 16. Each device has a number of bearer technologies available through respective bearer units or transceivers, and antennae. In particular this includes but is not limited to a narrowband bearer such as LMR and a broadband bearer such as LTE. Further, each bearer unit within a mobile device is connected to a processing platform referred to as a hub which is also able to offer services to applications either on board or to external connected devices. Each hub typically contains a processor and memory containing software instructions and is also connected to a GPS receiver in order to determine location data. In this example, neither mobile device 15 or 16 is within coverage of the broadband sites 11 and 12 yet they are both within coverage of the LMR site 10. Both mobile devices have data to be transferred which requires the relatively high data rate capability of broadband.

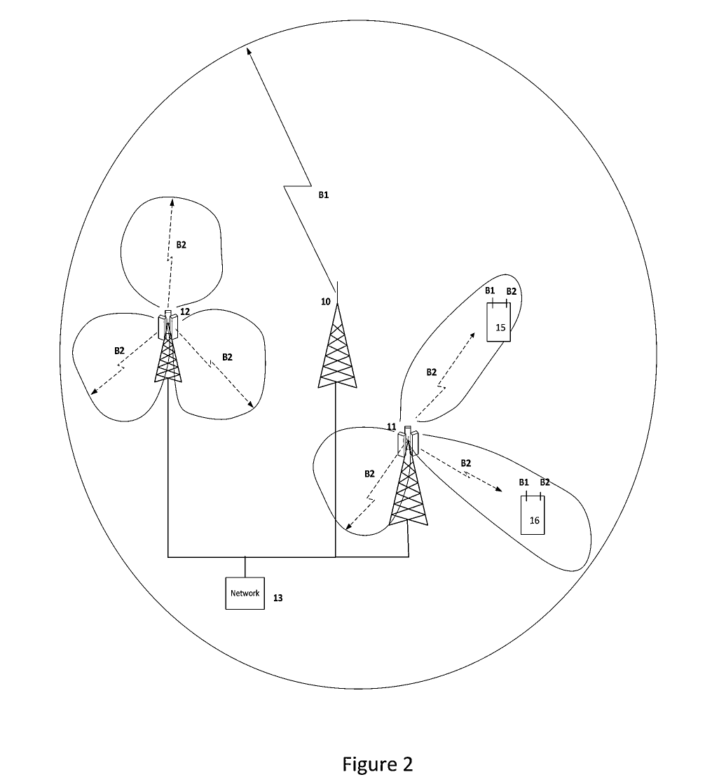

FIG. 2 offers a visualisation of how broadband connectivity can be achieved in FIG. 1. In this case, both mobile devices 15, 16 are closest to the broadband site 11 and each device is close to an individual sector of the site. Location information is transmitted by the mobile devices over the LMR system and processed in the control system 13. The broadband sectors of site 11 are directed towards the mobile devices thus enabling broadband communication. The antenna technology required to form and direct the sectors or beams of a broadband system is well known and need not be described in detail. It will be appreciated that forming a directional beam includes forming the beam use of an adaptive antenna, orienting the beam at a moveable antenna, or selecting the beam from a range of antennae.

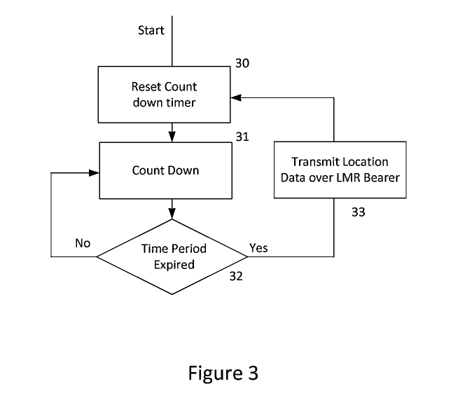

FIG. 3 is a flow diagram illustrating how a mobile device is configured to periodically communicate location data over the LMR network. A timer is set 30 and then counts down 31. When the time period has expired 32 the current location information for the mobile is sent 33 to the network. The rate at which the position is reported is generally related to the expected speed of mobility of the terminal device. In one example the terminal device may report its location every 10 seconds. This represents a practical time scale to allow for a change in position that may require slight adjustment of the beam direction.

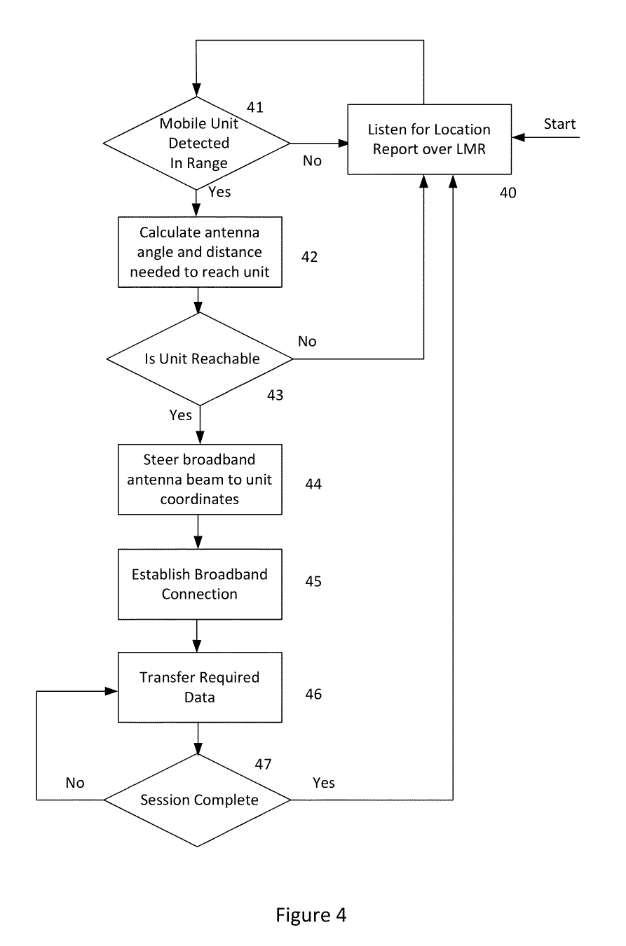

FIG. 4 is a flow diagram showing operation of the control system in the combined LMR and LTE networks. From start, the system is listening 40 for reports coming over the

LMR network offering location status for the mobile devices 15 or 16. Upon reception of a location report 41 along with a flag indicating the need to communicate high rate data, the controller will calculate which sector is best aligned to serve the device and calculate 42 the angle and reachability of the device. If it is possible 43 to reach the device then a beam will be directed 44 to those coordinates for the duration of the session. A broadband connection is established 45 and data is transferred 46 until the session is complete 47.

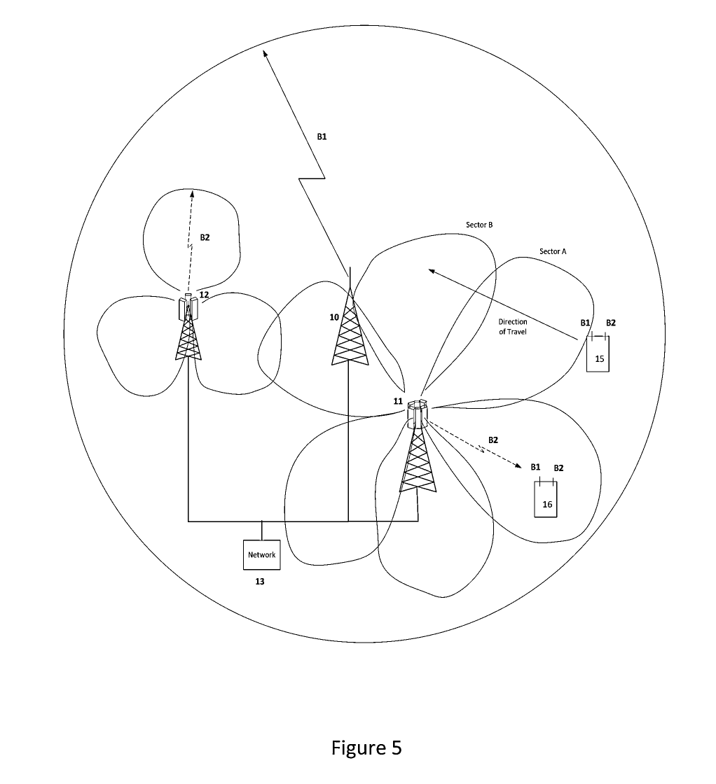

FIG. 5 shows an alternative system in which site 51 is populated with multiple directional antennae which provide coverage over multiple sectors. Mobile device 15 is travelling from sector A into sector B. Location data is transmitted by the mobile device while travelling. At a suitable stage the communication between the mobile and site 51 changes from the antenna for sector A to the antenna for sector B so that broadband connectivity is maintained. Otherwise a message may be sent to the mobile to indicate that coverage could be lost depending on the extent of travel.

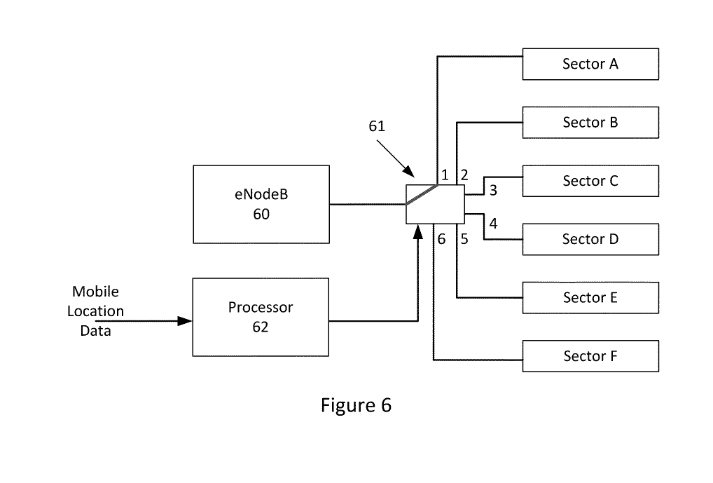

FIG. 6 shows a switching system for multiple antennae at a cellular base site. In this case a single broadband base station 60, referred to as eNodeB in LTE, is connected to one of six directional antennae A to F. An RF switch 61 is controlling which antenna is selected at any time on lines 1 to 6. This switch is controlled by a processor 62 which receives mobile location data and operates a software algorithm to calculate which switch position will be selected.

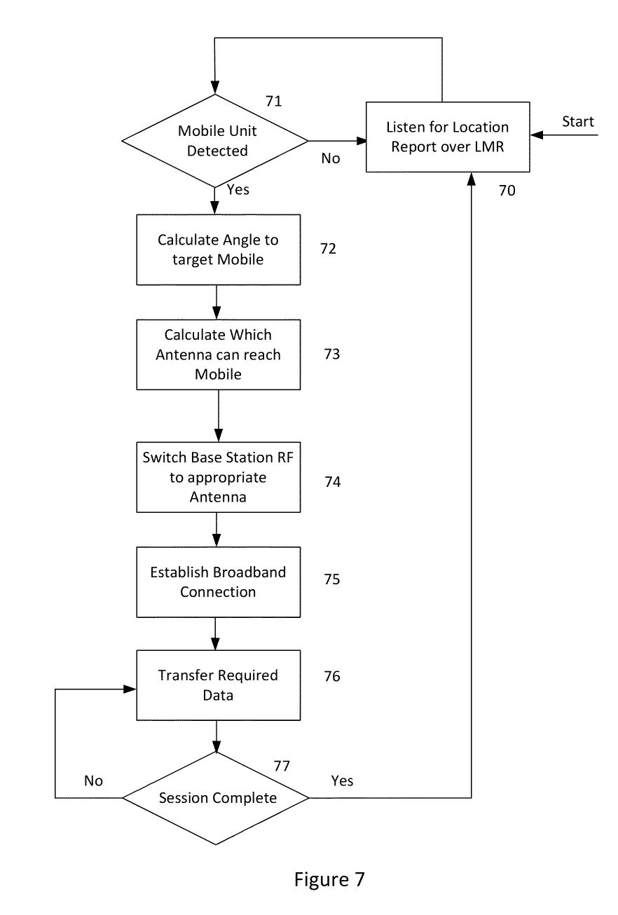

FIG. 7 is a flow diagram for calculating which antenna should be selected in FIG. 6. Initially, the system is waiting 70 for location data from a mobile device. Once suitable data has been received 71 an angle from the base station to the mobile unit is calculated 72. Given this angle and knowing the antenna configuration, the optimal antenna for communicating with the mobile device is selected 73. The switch 61 is then actuated 74 to connect the base station to the antenna. A broadband connection can then be established 75 with mobile device to enable transfer 76 of data at a relatively high rate. The session is eventually completed 77.

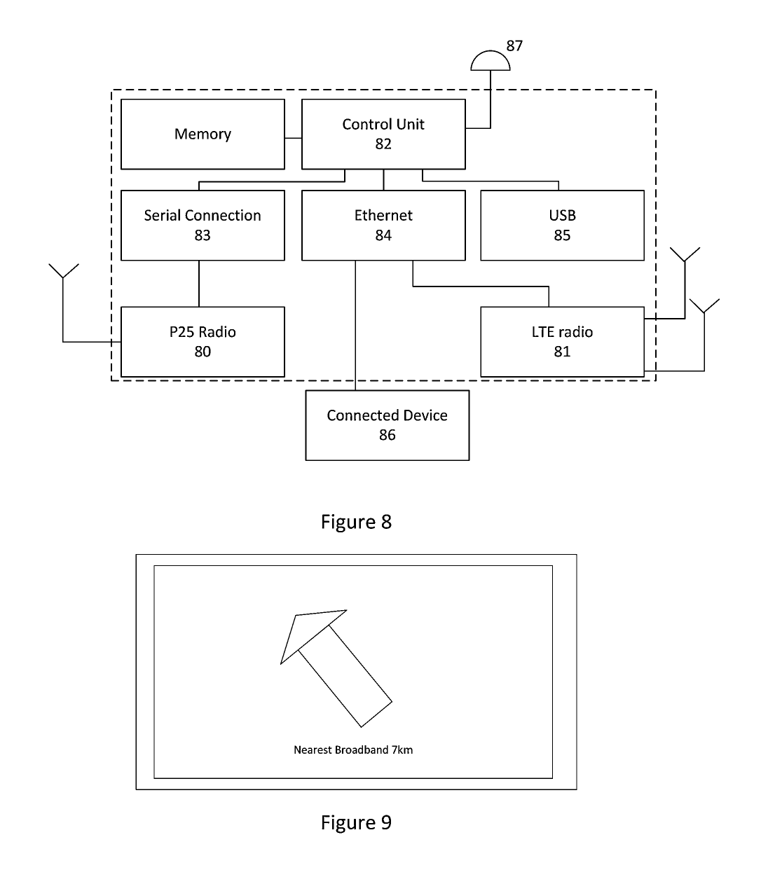

FIG. 8 shows a mobile device or terminal in the system of FIG. 1. The device has a transceiver for each bearer through which an RF connection is required, in this case a P25 radio 80 and an LTE radio 81, each with a respective antenna system. The transceivers are operated by a control unit 82 which sends or receives data through serial connection 83, Ethernet connection 84 or USB connection 85, for example. In this example, the control unit is managing traffic flow from an external device 86 such as a laptop, via the Ethernet interface. Periodically, the control unit also monitors GPS location from an attached GPS unit 87, and reports location data over LMR, using the P25 radio, as shown in FIG. 3. Location information can be carried by a number of package types including TSBK (Trunked Signalling Block) on a P25 control channel. In another form, the location information can be reported as P25 packet data on either traffic channels or conventional radio channels.

Preferably the mobile device is reporting its own location data to the overall infrastructure using the LMR network of base stations. In another form, the infrastructure can conversely report the location of broadband sites, and the estimated coverage of those sites, to mobile devices via the LMR network. A periodic broadcast of site information over the LMR network can be made. A mobile receiving the location of broadband sites has two options.

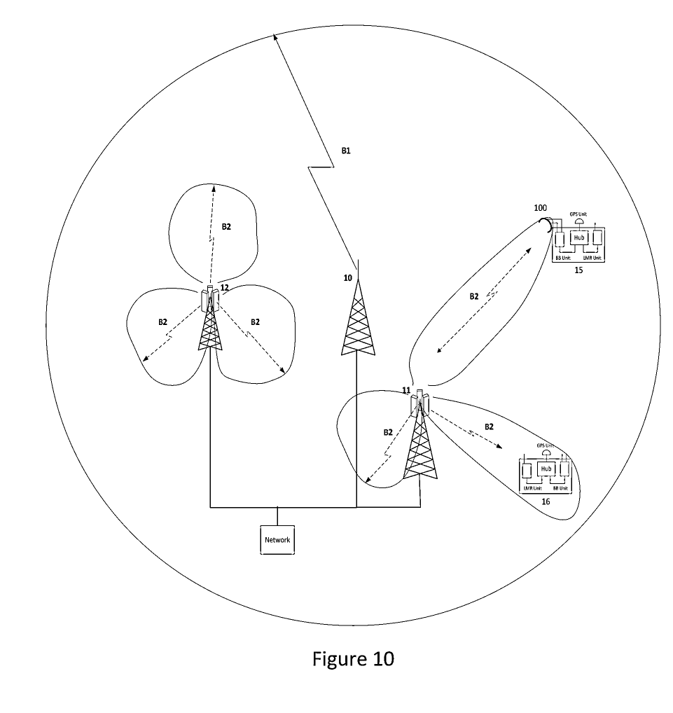

FIG. 9 illustrates how the user of a mobile device can be simply informed about the nearest available broadband connectivity. An arrow graphic indicates a direction and distance of travel for the user in order for broadband connectivity to be established. The indicated travel would bring the mobile device into one of the sectors of a nearby broadband site.

FIG. 10 illustrates the effective range of broadband connectivity can be extended as a result of a directional antenna 100 in the mobile device. Alternatively or as well as the indication in FIG. 9, the control unit 82 can operate the directional antenna to be directed toward a nearby broadband site in order to establish connectivity.

1. A method of communicating with a mobile radio device, including:
providing a first network of base stations which use a first bearer having a relatively low data rate,
providing a second network of base stations which use a second bearer having a relatively high data rate,
receiving location data from the mobile device at a base station using the first bearer,
providing a directional beam toward the location of the mobile device at a base station using the second bearer, and
transmitting data to or receiving data from the mobile device using the directional beam and the second bearer.

2. A method according to claim 1 wherein providing the directional beam includes forming the beam at an adaptive antenna, orienting the beam at a moveable antenna, or selecting the beam from a range of antennae.

3. A method according to claim 1 further including :
receiving data at the mobile device relating to the directional beam, and
moving the mobile device into the directional beam.

4. A method according to claim 1 wherein the first network of base stations provides omnidirectional relatively long range RF communication and the second network of base stations provides directional relatively short range RF communication.

5. A method according to claim 1 wherein the first bearer is LMR, DMR, TETRA or other relatively narrowband RF bearer, and the second bearer is LTE or other relatively broadband RF bearer.

6. A system for communicating with a mobile radio device, including:
a first network of base stations which use a first bearer having a relatively low data rate,
a second network of base stations which use a second bearer having a relatively high data rate, and
a controller having a memory containing software instructions which cause the controller to:
receive location data from the mobile device at a base station using the first bearer,
provide a directional beam toward the mobile device at a base station using the second bearer, and
transmit data to or receive data from the mobile device using the directional beam and the second bearer.

7. A system according to claim 6 wherein base stations in the first network provide services using LMR, DMR, TETRA or other relatively long range bearer, and base stations in the second network provide services using LTE or other relatively short range bearer.

8. A method of communicating with a mobile radio system, including:
providing a mobile device having capability for using either of a first bearer with a relatively low data rate or a second bearer with a relatively high data rate,
receiving data from a first base station using the first bearer, relating to location of a second base station which uses the second bearer,
providing a directional beam from the mobile device toward the location of the second base station which uses the second bearer, and
transmitting data from or receiving data at the mobile device using the directional beam and the second bearer.

9. A method according to claim 8 wherein providing the directional beam includes forming the beam at an adaptive antenna, orienting the beam at a moveable antenna, or selecting the beam from a range of antennae.

10. A method according to claim 8 wherein the first network of base stations provides omnidirectional relatively long range RF communication and the second network of base stations provides directional relatively short range RF communication.

11. A method according to claim 8 wherein the first bearer is LMR, DMR or other relatively narrowband RF bearer, and the second bearer is LTE or other relatively broadband RF bearer.

12. A method according to claim 8 further including:
receiving data from the first base station relating to the directional beam, and
moving the mobile device into the directional beam.

13. A method according to claim 12 further including:
providing a user of the mobile device with directions for moving the mobile device into the directional beam.

14. A mobile device for communicating with a mobile radio system, including:
a transceiver arrangement having capability for using either of a first bearer with a relatively low data rate or a second bearer with a relatively high data rate, and
a controller having a memory containing software instructions which cause the mobile device to:
receive data from a first base station using the first bearer, relating to location of a second base station which uses the second bearer,
provide a directional beam from the mobile device toward the second base station which uses the second bearer, and
transmit data or receive data at the mobile device using the directional beam and the second bearer.

15. A mobile device according to claim 14 wherein the first bearer is LMR, DMR or other relatively long range bearer, and the second bearer is LTE or other relatively short range bearer.
